(19) United States
(12) Patent Application Publication
(10) Pub. No.: US 2013/0119119 A1
(43) Pub. Date: May 16, 2013

(54) SOLDER SPATTERING SUPPRESSED REFLOW METHOD

(71) Applicant: HORNG CHIH HORNG, HSINCHU CITY 300 (TW)

(72) Inventor: HORNG CHIH HORNG, HSINCHU CITY 300 (TW)

(73) Assignee: ABLEPRINT TECHNOLOGY CO., LTD., HSINCHU CITY (TW)

(21) Appl. No.: 13/417,456

(22) Filed: Mar. 12, 2012

(30) Foreign Application Priority Data
Nov. 15, 2011 (TW) 100141502

(51) Int. Cl. B23K 31/02

(52) U.S. Cl. 228/246; 228/256

(57) ABSTRACT

A solder spattering suppressed reflow method includes the following steps: (A) preparing a carrier; (B) placing at least one solderable object on the carrier by means of printing, dispensing, mounting or plating; and (C) moving the carrier into an enclosed chamber and carrying out a high-temperature and high-pressure reflow process to have the solderable object heated and melted to bond to the carrier.

### BACKGROUND OF THE INVENTION

1. Field of the Invention

The present invention relates to a soldering method, and in particular to a reflow method in which solder spattering can be effectively suppressed.

2. The Related Arts

From a traditional printed circuit board to high-end chip assembling, no matter it is to mount passive components and electronic devices to a printed circuit board or it is to form a stack of electronic chips, using solders as connections between an electronic device and a carrier, or between carriers, for transmission of electrical signal is a common practice. With the current trend of electronic mobile devices being light-weighted and compact and the operation of chip and integration and complication of chips being increasingly high, the size of electronic devices or components used are getting smaller and smaller and the pitch of soldering spots is getting smaller and smaller. The long-existing problem of solder spattering occurring in solder reflow process that often leads to undesired bridging and contamination is getting severer due to the shortening pitch or distance between solders

Referring to FIG. 1, a flow chart of a conventional reflow method is illustrated. As shown in FIG. 1, a carrier is first prepared (Step S101). Then, a solderable object to be soldered is placed on the carrier in which at least a solderable object is positioned on the carrier through printing, dispensing, pick-and-place, or plating (Step S102) and a component to be joined is positioned on the solderable object (Step S103); or alternatively, a component that carries at least a solderable object attached on the component is directly placed on the carrier (Step S104). Afterwards, the carrier is moved into a normal-pressure high-temperature reflow oven or a low-pressure high-temperature reflow oven and carrying out a reflow process (Step S105) so as to have the solderable object heated and melted to bond to the carrier. Here, the term “low pressure” refers to a pressure lower than one atmosphere. In addition, the solderable object used here is generally consisting of at least one of tin, silver, copper, gold, indium, lead, bismuth, and zinc. In addition, the carrier used here refers to at least one of a printed circuit board, a substrate, a wafer, a chip, a silicone interposer, and a package.

The conventional reflow process includes a preheating zone, a soaking zone, a reflow zone, and a cooling zone. Solder spattering may occur in different zones due to the use of different types of solder. For example, a solder paste is prone to spattering in the preheating zone, the soaking zone, and the reflow zone, while a solder ball is prone to spattering in the reflow zone. Solder spattering is generally caused by the gases that are formed by high temperature evaporation of a solvent or a solder flux contained in the solder and are not properly released or the high-pressure bubbles that are formed, in a high temperature, with air bubbles or water that are included in the solder in a printing process and are not properly released. The molten solder or the solder bead that is not yet melted is squeezed and burst and thus spatters outward to cause contamination and solder bridging. Thus, to improve the issue of solder spattering, the gases contained in the solder must be removed in the reflow process. However, even through certain controls have been made of the environment and parameters of processing regarding to temperature rising rate of reflow oven, holding time of material before reflowing, environmental humidity, bubble inclusion of solder after printing, it is still not possible to effectively improve the issue of solder spattering.

A vacuum reflow oven is now available, which carries out reflow process in a vacuum environment of a low pressure in order to have an existing or derived gas expelled through the vacuum. However, there are still uncertain factors existing in the vacuum reflow oven, such as temperature difference between a heating zone in front of or behind the vacuum zone and not obvious effect of gas expulsion from solder if solder is oxidized seriously, influence of unit throughput, and excessively high facility expenditure. For the industry, the advantages of the vacuum reflow oven have not yet been confirmed through a large number of mass production operations.

### SUMMARY OF THE INVENTION

Thus, an objective of the present invention is to provide a reflow method that make use of the existence of a high pressure environment to expel gas that exists in solder or that derives from the solder in order to achieve an effect of suppressing solder spattering thereby achieving the purposes of high quality, high throughput, low cost, and mass production.

The solution adopted in the present invention to overcome the problems of the conventional techniques comprises a solder spattering suppressed reflow method that comprises the following steps: (A) preparing a carrier; (B) placing solderable object on the carrier; and (C) moving the carrier into an enclosed chamber and carrying out a high-temperature and high-pressure reflow process to have the solderable object heated and melted to bond to the carrier, wherein for the high-temperature and high-pressure reflow process, the pressure of the enclosed chamber is set to be greater than 1.3 atm and the temperature is set to be lower than 400 degrees Celsius.

### BRIEF DESCRIPTION OF THE DRAWINGS

The present invention will be apparent to those skilled in the art by reading the following description of the best mode for carrying out the present invention, with reference to the attached drawings, in which:

FIG. 1 is a flow chart of a conventional reflow method; and

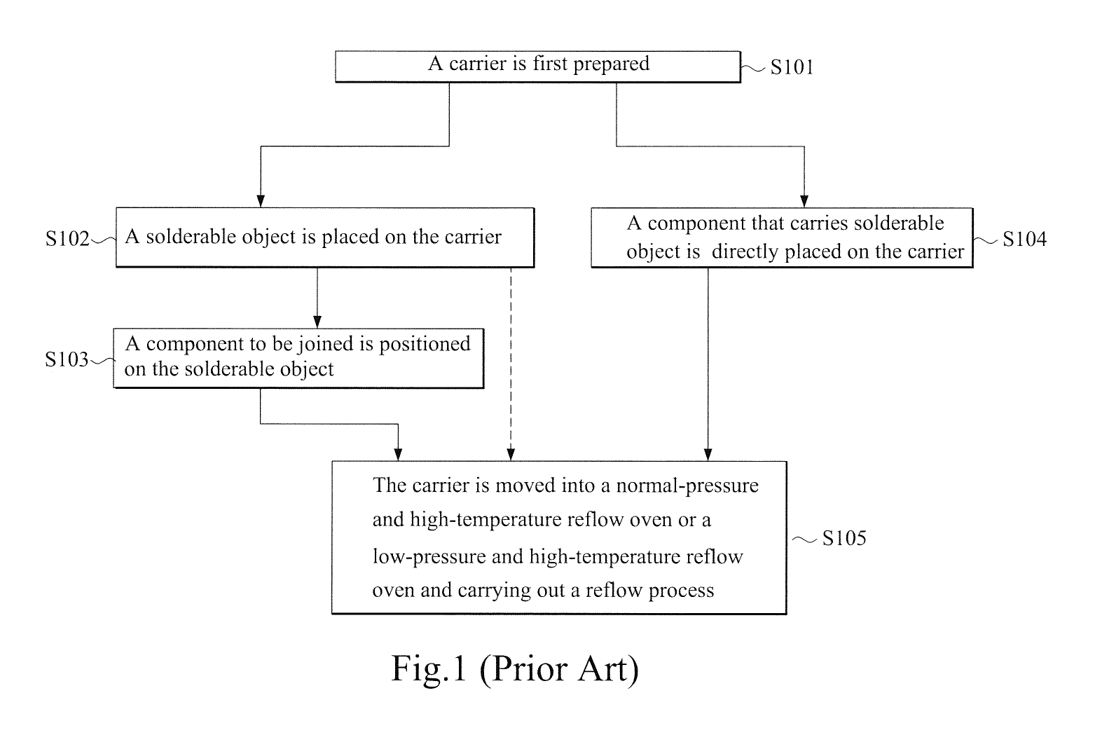

FIG. 2 is a flow chart of a solder spattering suppressed reflow method according to a preferred embodiment of the present invention.

### DETAILED DESCRIPTION OF THE PREFERRED EMBODIMENTS

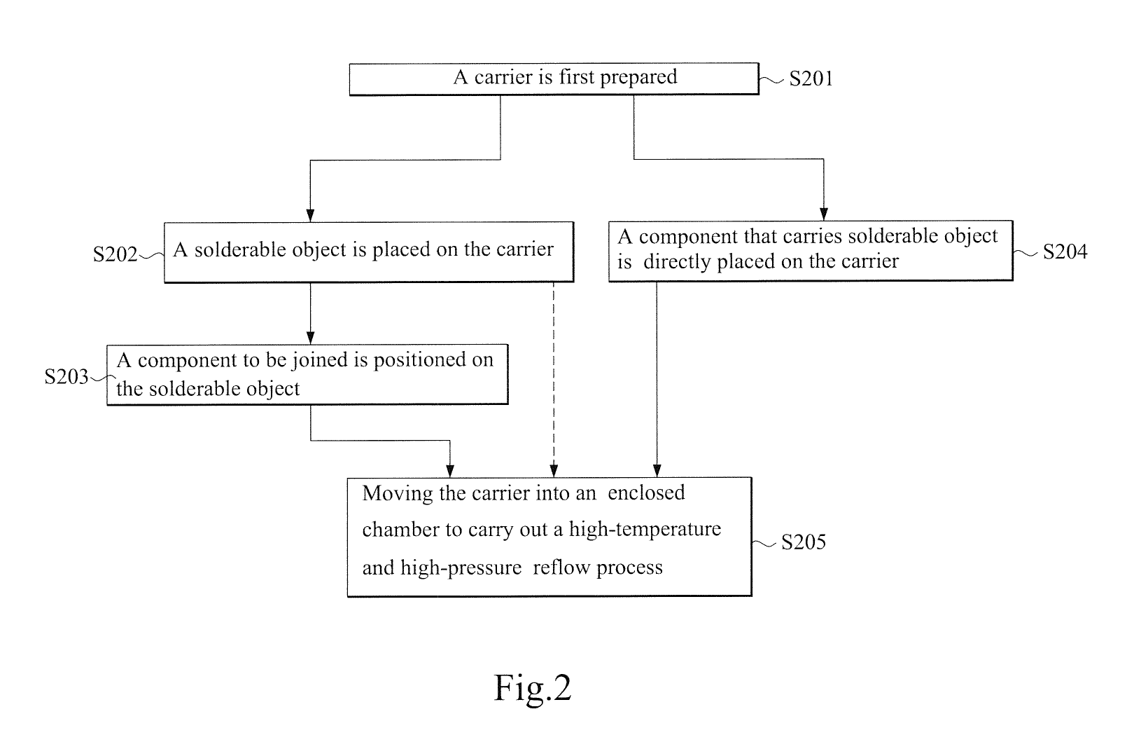

With reference to the drawings and in particular to FIG. 2, which is a flow chart of a solder spattering suppressed reflow method according to a preferred embodiment of the present invention. As shown in the drawings, the method starts with preparing a carrier (Step S201); then placing a solderable object to be soldered on the carrier, preferably a printer being employed to print solderable object on the carrier, a dispenser being employed to dispense solderable object on the carrier, a ball mounting device being employed to mount solderable object on the carrier, or a solderable object plating equipment to plate the solderable object on the carrier (Step S202), and placing a component to be joined on the solderable object (Step S203), or alternatively or additionally, directly placing a component that carries at least one solderable object attached on the component on the carrier (Step S204), in which the solderable object comprises a composition that preferably includes one of tin, silver, copper, gold, indium, bismuth, and zinc; moving the carrier into an enclosed chamber to carry out a high-temperature and high-pressure reflow process (Step 205) so as to have the solderable object melted and thus bonding to the carrier.

In step S203, the component placed on the solderable object may be without component solder. In alternative, the component may carry at least one component solder thereon corresponding to the solderable object on the carrier, so that the component solder of the component may be heated and melted to bond to the solderable object on the carrier in the high-temperature and high-pressure reflow process in step S205.

Here, the high-temperature and high-pressure chamber can be included in a stand-alone apparatus, or alternatively, connected in line with normal-pressure high-temperature reflow oven to provide a chamber for a continuous process.

When the chamber is included in a stand-alone apparatus, the chamber comprises at least one opening so that a user is allowed to set temperature and pressure and time inside the chamber. The gas pressure source is an inert gas supplied externally, such as nitrogen. For the high-temperature and high-pressure reflow process, the enclosed chamber has a pressure that is set to be greater than 1.3 atm and the temperature is set below 400 degrees Celsius.

To carry out reflowing, the carrier with solderable object placed thereon is put into the chamber and all openings are closed to form an enclosed chamber. Setting and execution are performed according to the desired internal temperature and pressure inside the chamber and time and after the reflow process is completed, the gas pressure is released and the temperature of the chamber is lowered down to allow finally removal of the carrier of which soldering is completed.

If the reflow oven is connected in line with conventional normal-pressure high-temperature reflow oven to form a continuous chamber, the high-temperature and high-pressure chamber comprises at least one opening to allow a user to place a carrier to be soldered into the interior of the high-temperature and high-pressure chamber. The openings are then closed and setting and execution are performed for desired temperature, pressure, and time. When the reflow process is completed, the gas pressure is released, the opening opened, and subsequent process is carried out.

The solder spattering suppressed reflow method according to the present invention is to apply a gas pressure that is of high density, easy to achieve uniform temperature, and homogenous, so that solvent or flux of the solderable object can be moderately released when evaporated in high temperature, or alternatively, to allow the solderable object to be forced, in a molten and low viscosity condition, by the applied surrounding high pressure to invade into derivative gas bubbles that is of a lower pressure or existing gas bubbles so as to have the gas bubbles to be squeezed outward from the inside. Here, the solderable object is filled in the voids inwardly from the outside and this is different from the conventional way that is performed in a normal pressure or vacuum so as to release or withdraw the gas bubbles outward from inside the solderable object to the outside. By supplying an external high pressure environment to the solderable object, the pressure difference is made large and improved gas bubble release result can be achieved. Due to the mechanism for releasing gas being different, there will be no solder spattering issue.

Further, according to the solder spattering suppressed reflow method, the application of high pressure environment is provided in an enclosed and pressure increasable high temperature oven, where heat convection is applied inside an enclosed oven containing high density of gas. Compared to the conventional open type reflow oven, the present invention can effectively reduce the amount of nitrogen used for oxidation protection. Compared to the enclosed vacuum reflow oven, the present invention may achieve excellent temperature homogeneity for large area solder and allows of batch processing of reflow. Consequently, the reflow method of the present invention can effectively achieve the purposes of high quality, high throughput, low cost, and mass production.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A solder spattering suppressed reflow method, comprising the following steps:
(A) preparing a carrier;
(B) placing at least one solderable object on the carrier; and
(C) moving the carrier into an enclosed chamber and carrying out a high-temperature and high-pressure reflow process to have the solderable object heated and melted to bond to the carrier.

2. The solder spattering suppressed reflow method as claimed in claim 1, wherein the carrier is at least one of a printed circuit board, a substrate, a wafer, a chip, a silicone interposer, and a package.

3. The solder spattering suppressed reflow method as claimed in claim 1, wherein the solderable object has a composition comprising at least one of tin, silver, copper, gold, indium, bismuth, and zinc.

4. The solder spattering suppressed reflow method as claimed in claim 1, wherein the solderable object comprises solder paste or solder ball.

5. The solder spattering suppressed reflow method as claimed in claim 1, wherein in Step (B), the solderable object is printed on the carrier with a printer.

6. The solder spattering suppressed reflow method as claimed in claim 1, wherein in Step (B), the solderable object is dispensed on the carrier with a dispenser.

7. The solder spattering suppressed reflow method as claimed in claim 1, wherein in Step (B), the solderable object is mounted on the carrier with a ball mounting machine.

8. The solder spattering suppressed reflow method as claimed in claim 1, wherein in Step (B), the solderable object is plated on the carrier with a plating process.

9. The solder spattering suppressed reflow method as claimed in claim 1, further comprising a step of placing a component to be soldered on the solderable object after Step (B).

10. The solder spattering suppressed reflow method as claimed in claim 9, wherein the component further carries at least one component solder thereon.

11. The solder spattering suppressed reflow method as claimed in claim 1, wherein the enclosed chamber is set to have a pressure greater than 1.3 atm in the high-temperature and high-pressure reflow process in Step (C).

12. The solder spattering suppressed reflow method as claimed in claim 1, wherein the enclosed chamber is set to have a temperature lower than 400 degrees Celsius in the high-temperature and high-pressure reflow process in Step (C).

13. A solder spattering suppressed reflow method, comprising the following steps:
(A) preparing a carrier;
(B) placing a component carrying at least one solderable object on the carrier; and
(C) moving the carrier into an enclosed chamber and carrying out a high-temperature and high-pressure reflow process to have the solderable object of the component heated and melted to bond to the carrier.

14. The solder spattering suppressed reflow method as claimed in claim 13, wherein the carrier is at least one of a printed circuit board, a substrate, a wafer, a chip, a silicone interposer, and a package.

15. The solder spattering suppressed reflow method as claimed in claim 13, wherein the solderable object has a composition comprising at least one of tin, silver, copper, gold, indium, bismuth, and zinc.

16. The solder spattering suppressed reflow method as claimed in claim 13, wherein the solderable object comprises solder paste or solder ball.

17. The solder spattering suppressed reflow method as claimed in claim 13, wherein the enclosed chamber is set to have a pressure greater than 1.3 atm in the high-temperature and high-pressure reflow process in Step (C).

18. The solder spattering suppressed reflow method as claimed in claim 13, wherein the enclosed chamber is set to have a temperature lower than 400 degrees Celsius in the high-temperature and high-pressure reflow process in Step (C).
